(19) United States
(12) Patent Application Publication
(10) Pub. No.: US 2014/0268142 A1
(43) Pub. Date: Sep. 18, 2014

(54) METHOD AND DEVICE FOR DETERMINING THE SIZE OF A TRANSPARENT PARTICLE

(71) Applicant: TECHNISCHE UNIVERSITAET DARMSTADT, Darmstadt (DE)

(72) Inventors: Cameron TROPEA, Gross-Umstadt (DE); Walter SCHAEFER, Aschaffenburg (DE)

(21) Appl. No.: 14/181,789

(22) Filed: Feb. 17, 2014

Related U.S. Application Data
(63) Continuation of application No. PCT/EP2012/066129, filed on Aug. 17, 2012.

(30) Foreign Application Priority Data
Aug. 17, 2011 (DE) 10 2011 052 783.4
Mar. 20, 2012 (DE) 10 2012 102 363.8

(51) Int. Cl. G01N 15/02

(52) U.S. Cl. CPC G01N 15/0205
USPC 356/340

(57) ABSTRACT

A method is described for determining the size of a transparent particle (2), wherein the particle (2) is illuminated with light from a light source (6), wherein using a radiation detector (7) a time-resolved intensity curve of light from the light source (6) scattered on the particle (2) is measured at a preselectable scattering angle θₛ, wherein characteristic scattered light peaks are determined in the intensity curve, and wherein the size of the particle (2) is determined on the basis of the time difference between two scattered light peaks, characterized in that, with the help of two radiation detectors (7) or light sources (6), a first and a second time-resolved intensity curve of scattered light, scattered on the particle (2) in the forward direction, are measured; a transmission peak (12) and a reflection peak (11) are determined from the first intensity curve and from the second intensity curve; a first time difference between the transmission peaks (12) is determined, and a second time difference between the reflection peaks (11) is determined; a characteristic variable α is determined from the ratio of the first time difference and the second time difference; and a size determination is performed for the particles (2) for which the characteristic variable α corresponds to a preselectable value.

The invention relates to a method for determining the size of a transparent particle, wherein the particle is illuminated with light from a light source, wherein a time-resolved intensity curve of light from the light source scattered on the particle is measured with a radiation detector at a preselectable scattering angle θₛ, wherein characteristic scattered light peaks are determined in the intensity curve and the size of the particle is determined on the basis of a time difference between two scattered light peaks.

It is extremely important for research as well as for industrial and commercial utilization of products and processes to be able to determine various characteristic properties of individual particles in the size range of one millimeter or less. The respective properties of interest often relate to the size, shape, velocity and refractive index of individual particles. Simultaneous determination of both the size and velocity of individual particles is of particular interest because, with this information, a flow density can be determined, such as a mass flow or a volume flow. In addition, individual particles in a large number of particles can be identified and characterized individually such as, for example, individual drops in an aerosol or spray.

Determination of characteristic properties of individual droplets is needed for optimization of fuel injection processes for injecting fuel into a combustion chamber, for example, or for characterization of a spray stream of paint or enamel during a spraying process. The particles whose properties are to be determined are not exclusively liquid droplets in a gas such as air, for example, but instead they are solid particles, gas bubbles in a liquid or a droplet emulsion of a first liquid distributed in a second liquid, depending on the application.

Various measurement methods are known from practice. In many cases, optical measurement methods are advantageous because they have no influence at all on the individual particles, whose properties are to be determined, or not to any mentionable extent.

The optical measurement methods known from practice and research include, for example, imaging techniques with a high degree of time resolution, intensity measurements, interferometry or the analysis of reflected and refracted beams of light scattered by a particle to be measured.

Most of the measurement methods mentioned above make various assumptions about some properties of the particles, depending on the process, or they require corresponding defaults in order to be able to determine the desired properties in conjunction with the measured values. A necessary prerequisite in many cases is the assumption that the individual particles have a spherical shape or surface.

It has been found that a substantial equipment investment is usually required to be able to perform the measurements necessary for determining the characteristic properties. Likewise only a few methods permit simultaneous determination of the size and velocity of individual particles. Therefore, in many cases, several different measurements must be performed on the same particle to be able to determine one or more relevant properties. There is the problem of being able to reliably assign the measurement results of the various measurements to the same particle in order to permit a further evaluation of the measurement results and a determination of properties on the same particle, which depend on several measurement results.

A method of the generic type defined in the introduction makes use of the fact that the light reflected by a particle and the light scattered or refracted by that particle at the same angle due to birefringence can be detected with a time shift.

The time difference between the two peaks and/or intensity maximums of the reflected and refracted scattered light can be used under certain prerequisites and with a known particle velocity to determine the size of the particle. The particle velocity can be determined by a different measurement method, e.g., with the help of a laser Doppler system. For example, one such method is described by N. Damaschke, H. Nobach, N. Semidetnov, C. Tropea (2002), Optical Particle Sizing in Backscatter, Applied Optics 41, 5713-5727 or by A. Kretschmer, N. Damaschke, N. Semidetnov, C. Tropea (2006), Application of the Time-Shift Technique for Spray Measurement, 13^{th} Int. Symp. on Appl. Laser Techniques to Fluid Mechanics, Lisbon, Portugal, Jun. 26-29, 2006.

Although this measurement method yields good results in theory, its practical benefit is often limited. For example, various intensity peaks may also be created due to the fact that two different particles are illuminated by the light source one after the other and scattered light is dispersed in the direction of a beam detector. In the case of dense particle collections in particular, individual peaks can no longer be assigned reliably to individual particles. Furthermore, the shape of the measured particles may deviate from a spherical shape, so that the geometric assumptions made for the determination of size are not correct and the values determined may differ significantly from the actual size values. To be able to check on the reliability of the measurement results, a substantial equipment investment is required, leading in many cases to the fact that this measurement method cannot be used in an economically reasonable manner.

One object of the present invention is therefore to create a method of the generic type defined in the introduction for determining the size of a particle, so that a reliable determination of particle size is made possible with the lowest possible structural investment.

This object is achieved according to the invention by the fact that a first and a second time-resolved intensity curve of scattered light dispersed on the particle from the light source in the forward direction are measured either with two radiation detectors arranged with a distance between them in the direction of trajectory of the particles and on both sides of an optical axis of the light source or the particle is illuminated with two light sources arranged with a distance between them in the direction of the particle trajectory and on both sides of an optical axis of the radiation detector and the time-resolved intensity curve of scattered light dispersed in the forward direction and measured with the radiation detector is broken down into a first intensity curve, caused by the first light source, and the second intensity curve, caused by the second light source, such that a transmission peak and a reflection peak are each determined from the first intensity curve and from the second intensity curve; a first time difference between the transmission peak of the first intensity curve and the transmission peak of the second intensity curve and a second time difference between the reflection peak of the first intensity curve and the reflection peak of the second intensity curve are determined; a characteristic variable α is determined as the ratio of the first time difference and the second time difference, and a size determination for which the characteristic variable α corresponds to a preselectable value is performed only for those particles for which the characteristic variable α corresponds to a preselectable value.

This makes use of the fact that the interval of time separating multiple scattered light peaks from one another conforms to given laws and depends on only a few characteristic properties of the respective particle in the scattered light, which is scattered, i.e., created, by a particle. If an ideal spherical shape is assumed for the particle, then the intervals of time of the multiple scattered light peaks from one another depend only on the size and velocity of the particle as well as the scattered-light angle, such that the scattered-light angle is predefined by the measurement apparatus and is known to be a constant with sufficient precision.

Due to the arrangement of the measurement equipment, in particular the radiation detectors and the light sources, a correlation of the respective intensity curves over time can be performed, so that two intensity curves assigned to the same particle can be determined unambiguously.

The two radiation detectors or the two light sources (if only one radiation detector and two light sources are used) may each be arranged at any angle to the optical axis if the two radiation detectors and/or the two light sources are arranged on both sides of the optical axis.

However, it is preferably provided that either the two radiation detectors are arranged symmetrically on both sides of the optical axis of the light source and first and second time-resolved intensity curves are measured by the scattered light of the light source, which is scattered on the particle in the forward direction or the two light sources are arranged on both sides of an optical axis of the radiation detector symmetrically and the particle is illuminated by the two light sources arranged symmetrically and at a distance from one another in the direction of the particle trajectory.

Although a computer evaluation is fundamentally also possible for an asymmetrical arrangement, the relationships are simplified and thus the evaluation is simplified in the case of a symmetrical arrangement of the two radiation detectors and/or the two light sources. Therefore, a symmetrical arrangement is assumed in the further discussion, unless it is pointed out explicitly to the contrary in the following discussion.

If two time differences between two different pairs of scattered light peaks of the same particle are now compared with one another and if one characteristic variable describing this ratio is calculated, then the characteristic variables for all the particles which satisfy the presumed assumptions and have an ideal spherical shape should correspond, i.e., a corresponding ratio of these time differences should be determined. If the characteristic variable determined for a measurement on one particle deviates substantially, it must either be a faulty measurement or the assumption of an ideal spherical shape must be wrong.

Deviations from this assumption of an ideal spherical shape of the particle, which is responsible for the measured scattered light, are often caused by two or more particles passing simultaneously through the measurement volume, which is illuminated by the incident light.

With the measurement methods known so far, scattered light intensities superimposed in this way can be detected or evaluated reasonably only by ensuring the corresponding stipulations, namely that there will always be only one particle crossing the measurement volume. Alternatively, the measurement volume could be monitored with additional detectors, and in the case of multiple particles crossing the measurement volume at the same time, the measurement results would be discarded.

Using the method according to the invention, the measurement results themselves may be verified easily and the measured scattered light intensities, which do not allow a reasonable evaluation for determination of the characteristic particle properties, can be identified.

It is provided that the scattering angle θₛ measured between the optical axis and the light sources or the radiation detectors arranged in deviation therefrom is smaller than 90°. If the light scattered on the particle is measured at a forward scattering angle θₛ and in a particularly advantageous manner in a range θₛ of <65°, then the measurement instrument required to perform the measurement can be integrated into existing measurement equipment, which is already known from the prior art. The light yield and thus the signal strength of the reflection peaks and the transmission peaks, which may also be referred to as the refraction peaks of the first order, are comparatively high, so that precise measurement results can be obtained. An advantageous scattering angle θₛ also depends on the relative refractive index m of the particles whose scattered light is measured. For a refractive index m of approximately 1.6, the scattering angle θₛ should be less than 90°. For a refractive index m of 1.2, the scattering angle θₛ should be less than 60° up to 65° and for smaller refractive indices m, the scattering angle θₛ should definitely be less than 65° to permit the simplest and most reliable possible evaluation of the measured scattered light.

These considerations and relationships also apply similarly when an asymmetrical arrangement is used and therefore two different scattering angles θₛ⁽¹⁾ and θₛ⁽²⁾ must be taken into account.

The time difference between the reflection peak and a transmission peak can be used in a known manner to determine the size of the particles on which the incident light is scattered. This makes use of the fact that the time difference between the measurement signals for the reflection peak and for a transmission peak depends on the path length and the spatial distance of the differently scattered beams of light, which in turn depend on the particle size and the velocity at which the particle moves through the incident beam of light in a known manner.

If two different time differences, which are assigned to the respective intensity peaks of different intensity curves of the scattered light of the same particle, are put in a ratio to one another, then the ratio of the two time differences no longer depends on the size of the particle. For the characteristic variable α, which describes the ratio of two time differences between the reflection peaks on the one hand and the transmission peaks on the other hand of the two time-resolved intensity curves, the equation given below can be derived for a symmetrical arrangement and therefore identical scattering angles θₛ:

$$\frac{Δ {t}_{00}}{Δ {t}_{11}} = \frac{\frac{d}{v} cos ( \frac{{θ}_{s}}{2} )}{\frac{d}{v} sin ( {θ}_{i}^{p = 1} ( {θ}_{s} , m ) )} = \frac{cos ( \frac{{θ}_{s}}{2} )}{sin ( {θ}_{i}^{p = 1} ( {θ}_{s} , m ) )} := α ( {θ}_{s} , m )$$

The time differences Δt₀₀ and Δt₁₁ denote the time difference between the reflection peaks and/or between the transmission peaks in the two intensity curves. The particle diameter is labeled as d and the particle velocity is v. The angle of incidence θᵢ^{p=1} describes the angle of incidence of the light of the transmission peak (refraction peak of the first order) onto the particle. This angle of incidence θᵢ^{p=1} is in turn a geometric variable, which depends exclusively on the scattering angle θₛ and the relative refractive index m under the assumption of an ideal spherical shape of the particle. The angle of incidence θᵢ^{p=1} may be determined in advance by ray tracing programs, for example, or by suitable simulation programs. Consequently, the characteristic variable α depends only on the relative refractive index m of the particle in the ambient medium and the scattering angle θₛ as well as geometric conditions, which are fixedly predetermined and depend on the scattering angle.

This independence of the characteristic variable α on the particle size, which is determined by tests, can be used according to the invention to verify whether the measured values of a time-resolved intensity curve used for determination of the particle size originate from a single particle and not from a superpositioning of multiple scattering effects on different particles, for example. In addition, by means of the characteristic variable α, it is also possible to verify that the assumptions on which a reliable determination of particle size is based, such as an approximate spherical shape, are met, so that a relevant size determination can be performed.

Measured values for which the characteristic variable α deviates significantly from a predetermined value and/or a predetermined value range are not used for a determination of the particle size but instead are discarded. The number of particles for which a determination of particle size is performed is reduced by discarding the measured results for which the characteristic variable α does not correspond to the predetermined criterion. However, a significantly more reliable and thus more precise determination of the particle size can be performed for the remaining measured values.

When using the method according to the invention, it is no longer necessary to verify and validate the relevancy of individual measurement results by additional and independent measurements. The equipment complexity can be greatly reduced in this way without diminishing the precision or relevance of the measurement results accordingly.

It has been found that a reliable and precise determination of particle size is facilitated by the fact that the scattering angle θₛ or the two scattering angles θₛ⁽¹⁾ and θₛ⁽²⁾ are preselected, so that the characteristic variable α=Δt₀₀/Δt₁₁ is between 0.5 and 2.5, preferably approximately 1.5. The characteristic variable α depends only on the relative refractive index m, which is a known and constant variable for a known droplet material in an ambient medium, which is also known, in addition to the scattering angle θₛ. For a suitable stipulation of the scattering angle θₛ the value and/or value range for the characteristic variable α can be preselected, so that the time-resolved intensity curves measured at this scattering angle θₛ permit the most reliable possible determination of particle size. It has been found that, when the value of a characteristic variable α is in the range of 1.5, there are advantageous prerequisites for reliably separating, identifying and evaluating the individual peaks in the time-resolved intensity curve.

In addition, it is fundamentally also possible on the basis of the characteristic variable α to assign one of several previously known refractive indices to the particle. For example, if particles from two different materials are supplied to a measurement apparatus simultaneously, these two materials differing substantially from one another with regard to their respective refractive indices, then a first characteristic variable α₁ should be determined for all the particles of the first material and a second characteristic variable α₂ which differs substantially from the first characteristic variable α₁ should be determined for all the particles of the second material. All the particles for which the characteristic variable α₁ is determined may be assigned to the first material. All the particles for which the characteristic variable α₂ is determined can be assigned to the second material. All lateral intensity distributions for which a characteristic variable α₃ is determined which differs significantly from the two characteristic variables α₁ and α₂ are discarded because they do not permit a reliable evaluation and are obtained by an analysis of intensity peaks which cannot be assigned to a single particle or not to a particle suitable for an analysis.

According to an advantageous embodiment of the idea according to the invention, it is provided that a spatial intensity distribution of the light source along an optical axis is determined and compared with an intensity distribution of the reflection peak and/or at least one transmission peak over time. The light source used may fundamentally consist of any suitable light source whose light is scattered by the particles to be measured with sufficient intensity and whose focused diameter is small enough in relation to the particle size, so that there is an adequate time difference between the individual reflection peaks and transmission peaks for a predetermined scattering angle θₛ. The intensity distribution of any reflection peak or transmission peak over time corresponds to the spatial intensity distribution of the light source scanned uniformly by the droplets passing by. An approximately Gaussian spatial intensity distribution of the light source also leads to Gaussian intensity distributions of the reflection peaks and the transmission peaks over time.

It is provided that to improve the reliability and relevancy of the respective determinations of particle size to be performed, a size determination is performed only for those particles for which the refraction peak and/or the transmission peak has/have an intensity distribution over time, which correlates with the spatial intensity distribution of the light source. A differing and non-correlating intensity distribution is a reliable sign that the measured intensity distribution over time cannot be assigned to a single particle but instead was caused by superpositioning of the scattering components of multiple particles. It is also conceivable that the measured intensity distribution can be assigned to a single particle but that this particle does not have a spherical shape, for example. In both cases, the relevancy of a particle size determined with these measured values would be extremely low. For this reason, no determination of particle size is performed for such non-correlated intensity distributions.

According to a particularly advantageous embodiment of the idea according to the invention, it is provided that the velocity of the particle is determined from the width of the intensity distribution of the reflection peak over time and/or from the width of the transmission peak. In particular for the intensity distributions for which the plausibility checks mentioned above were performed successfully, the particle velocity can be determined starting from a characteristic width of the intensity distribution of a peak over time, if the correlating spatial beam width of the light source is known and/or can be determined in advance through measurements. If the determination of the particle velocity is performed on multiple peaks and/or on the reflection peak and on the transmission peak, then the accuracy of the particle velocity determination can be improved.

Additional measurement methods and an additional equipment complexity associated therewith are not necessary to be able to determine the particle velocity and with knowledge thereof also determine the particle size. Since only the intensity curve of the light of the light source scattered on the particle over time must be measured for the determination of particle size, the particle size can be determined rapidly, reliably and extremely inexpensively by using the method described above.

The invention also relates to a device for determining the size and velocity of a particle with a light source, which a radiation detector for light of the light source scattered by the particle and with an analysis device that can be connected to the radiation detector for data transmission. According to the invention, it is provided that additionally either one additional radiation detector or one additional light source

It is preferably provided that the light source does not emit coherent light. The light source may be, for example, a light-emitting diode (LED). The light source may also be formed by a plurality of LEDs arranged in a suitable manner. It is also possible for the light source to emit coherent light even if, in terms of the performance of the method according to the invention, it does not matter much whether the light source emits coherent light or noncoherent light.

To be able to perform a rapid and reliable particle size determination for a large number of particles that can optionally move in different directions, it is provided that the light source generates a light curtain.

Exemplary embodiments which are illustrated in the drawings are explained in greater detail below. They show:

FIG. 1 shows a schematic diagram of a particle illuminated by a light source and the curves of a few beams that have been drawn in the figures, occurring for a predetermined scattering angle θ_{S},

FIG. 2 shows a schematic relationship between the spatial intensity distribution of a beam of light of the light source striking the particle and an intensity distribution of the measured scattered light over time, which correlates with same,

FIG. 3 shows a schematic diagram of a device for determining the size of a particle,

FIG. 4 shows the schematically diagrammed intensity curves of light scattered by a particle in the scattering angle θₛ over time, the light being measured by a first radiation detector and a second radiation detector in the forward scattering direction,

FIG. 5 shows a schematic diagram of various values of the characteristic variable α as a function of various materials and/or refractive indices m of the particles and

FIG. 6 shows a schematic diagram of a device for determining the size of a particle like that in FIG. 3 but showing an asymmetrical arrangement of the two radiation detectors instead.

FIG. 1 shows schematically the relevant beams for determining the particle size for the method according to the invention in a scattering process in a scattering angle θₛ. Of a light source (not shown in FIG. 1), a beam of light 1 strikes a particle 2 which is moving through the beam of light 1 crossing through the beam of light 1. The beam of light 1 is reflected from the outside on the interface 3 of a particle 2 to the surrounding medium and transmitted through the particle 2 on emerging from the particle 2 through refraction on entrance and exit from the particle 2. FIG. 1 shows the solid-line beams for the reflection and for the transmission that occur at a predetermined scattering angle θₛ and can be detected. A reflection beam 4 is reflected at the interface 3. A transmission beam 5 is refracted into the interior of the particle 2 and is refracted again on emerging from the particle 2.

The respective angle of incidence θᵢ of the solid-line beams which generate corresponding intensity peaks in a time-resolved intensity curve correlates with the intersection with the interface 3 of the particle 2. For an assumed ideal spherical shape of the particle 2, the angle of incidence θᵢ may be determined as a function of the scattering angle θₛ used for the measurement and the refractive index m of particle 2 with the help of geometric considerations and/or with the help of ray tracing programs in practice.

Because of the different paths and transit times that can be determined in advance at a given scattering angle θₛ for the reflection beam 4 as well as for the transmission beam 5, the individual beams create chronologically spaced peaks which can be detected with a detector (not shown). Since the time difference between the individual peaks depends on the particle size, among other things, the particle size can be determined starting from a time-resolved intensity curve which was detected with the detector.

FIG. 2 shows only schematically the relationship between a spatial intensity distribution of the incident beam of light 1 and the intensity curve of the scattered light detected at scattering angle θₛ over time. An intensity distribution of the incident beam of light 1 which is essentially Gaussian leads to a curve of the measured intensity of the scattered light plotted as a function of time, which is also approximately Gaussian. Such an intensity peak can be measured for all the solid line beams described above.

The beam of light 1 striking the particle 2 is imaged in the detector due to the particle 2 crossing the beam of light 1, and this can be described by a mathematical transformation. The width b of the spatial intensity distribution of the incident beam of light 1 corresponds to the width a of the time-resolved peak of the scattered light. The particle velocity v is obtained from the quotient of the spatial width b and the time difference which corresponds to the width a:

v=b/σ.

The width b and the width σ can be determined, for example, based on a half-width determination of the respective peaks. The spatial intensity distribution of the incident beam of light 1 should therefore be determined in advance with the greatest possible precision.

A device for performing the method according to the invention, diagrammed as an example in FIG. 3, requires only a few inexpensive components. A light source 6 and two photodetectors 7 must be arranged and equipped relative to one another, so that the light, which is scattered by a particle 2 passing by and is generated by the light source 6, can be detected in both photodetectors 7 which are arranged at the same scattering angle θₛ relative to an optical axis 8 of the light source 6 and are directed at a corresponding measurement volume 9, the light source 6 is arranged on a first side of the measurement volume 9 and the two photodetectors 7 are arranged on the second side which is opposite the first side.

Since no interference properties need be utilized for determination of the particle size d, the light source 6 may be any sufficiently bright source of light that can be focused in a suitable manner. The light source 6 need not emit coherent light so that it is also possible to use LEDs, for example. If the sizes d of the particle 2 are to be determined with different trajectories, then the light source 6 may also be designed as a light curtain or the like. An analysis unit 10 is connected to the photodetector 7 for transmission of data and is suitable for analyzing a time-resolved intensity distribution measured with the photodetectors 7. The analysis unit 10 optionally has a suitable memory device for the measured values.

FIG. 4 shows schematically the two time-resolved intensity curves of the light scattered on particle 2 and measured by the two photodetectors 7 at the scattering angle θₛ. This is plotted as a function of the time t in μs, representing the intensity of the electric measurement signal S generated by a detector. Each intensity curve has a reflection peak 11 and a transmission peak 12, definitely separated from the former. Any peaks generated by scattering of a higher order do not have any mentionable intensity and are therefore negligible.

The time differences Δt₀₀ and Δt₁₁ can be determined as the difference in the respective maximums of the reflection peaks 11 and the transmission peaks 12. The two time differences Δt₀₀ and Δt₁₁ are derived according to

$$Δ {t}_{11} ( d , v , {θ}_{S} , m ) = \frac{d}{v} ( sin ( {θ}_{i}^{( p = 1 )} ( {θ}_{S} , m ) ) )$$

$$Δ {t}_{00} ( d , v , {θ}_{S} ) = \frac{d}{v} cos ( \frac{{θ}_{S}}{2} )$$

from the particle properties, i.e., the particle size d, particle velocity v and refractive index m, as well as from the scattering angle θₛ, which is predetermined by the measurement apparatus.

The time differences Δt₀₀ and Δt₁₁ each depend on the size d and the velocity v of the particle 2. However, a characteristic variable α, which is determined as the quotient of the two time differences Δtₘ and Δt₁₁ according to the following equation:

$$\frac{Δ {t}_{00}}{Δ {t}_{11}} = \frac{\frac{d}{v} cos ( \frac{{θ}_{s}}{2} )}{\frac{d}{v} sin ( {θ}_{i}^{p = 1} ( {θ}_{s} , m ) )} = \frac{cos ( \frac{{θ}_{s}}{2} )}{sin ( {θ}_{i}^{p = 1} ( {θ}_{s} , m ) )} := α ( {θ}_{s} , m )$$

is independent of the particle size d and the velocity v and depends only on the scattering angle θₛ and the relative refractive index m. The scattering angle θₛ can be predetermined by the equipment design of the measurement apparatus and/or by the arrangement and equipment of a detector relative to the light source.

The relative refractive index m can also be determined in advance from known particles 2 in a known medium. The angle of incidence θᵢ^{p=1} is a geometric variable, which depends only on the scattering angle θₛ and the relative refractive index m under the assumption of an ideal spherical shape of the particle, and can be determined in advance. Thus a table of values may also be calculated in advance for the characteristic variable α as a function of the parameters, and a value and/or a value range to which the characteristic variable α from the measured intensity distribution must conform in order for the respective intensity distribution to be taken into account and used for the determination of particle size.

If the measured intensity distribution should yield a substantially different characteristic variable α, this must regularly be attributed to the fact that the individual peaks 11 and 12 cannot be assigned to a single particle 2 but instead occur due to superpositioning of multiple scattering effects on different particles 2, for example, or the respective particle 2 does not have an approximately spherical shape and therefore the geometric boundary conditions assumed for the path distances and transit times of the solid line beams 4 and 5 are not correct.

Instead of or in addition to the ratio of the time differences Δt₀₀ and Δt₁₁, it is also possible to determine the time difference Δt₀₁ of the two peaks 11 and 12 in relation to one another in a measured intensity distribution and to use these differences in the respective ratio of the time differences Δt₀₀ and Δt₁₁ for the calculation of the characteristic variable α, where the following relationships hold:

$$\frac{Δ {t}_{00}}{Δ {t}_{11}} = \frac{\frac{d}{v} sin ( {θ}_{i}^{p = 1} ( {θ}_{s} , m ) ) + \frac{d}{v} cos ( \frac{{θ}_{s}}{2} )}{\frac{d}{v} sin ( {θ}_{i}^{p = 1} ( {θ}_{s} , m ) )} = 1 + \frac{cos ( \frac{{θ}_{s}}{2} )}{sin ( {θ}_{i}^{p = 1} ( {θ}_{s} , m ) )} := 1 + α ( {θ}_{s} , m )$$

$$and$$

$$\frac{Δ {t}_{01}}{Δ {t}_{00}} = \frac{\frac{d}{v} sin ( {θ}_{i}^{p = 1} ( {θ}_{s} , m ) ) + \frac{d}{v} cos ( \frac{{θ}_{s}}{2} )}{\frac{d}{v} cos ( \frac{{θ}_{s}}{2} )} = 1 + \frac{sin ( {θ}_{i}^{p = 1} ( {θ}_{s} , m ) )}{cos ( \frac{{θ}_{s}}{2} )} := 1 + \frac{1}{α ( {θ}_{s} , m )}$$

with each of these equations, the value of the characteristic variable α can be determined independently of the respective other relationships.

In addition, it is possible to perform two or three different calculations for the characteristic variable α and to compare the respective values obtained. If the values determined for the characteristic variable α do not match, the intensity distributions affected by this should not be used for an analysis because differences in the characteristic variable α also indicate that the individual peaks 11 and 12 cannot be assigned to a single particle 2.

In FIG. 5 the theoretically determined values for the characteristic variable α are plotted as a function of the scattering angle θₛ in degrees for various refractive indices between m=1.1 and m=1.7 in increments of 0.1 each. For the analysis of the measured values, a value of 1.5 is advantageous for the characteristic variable α. As a result, for a measurement of the size of water droplets in air with a refractive index m=1.33, for example, a scattering angle θₛ of approximately 21° is especially advantageous and should be taken into account and optionally preset for the structural design of a measurement apparatus.

For the purpose of illustration, FIG. 6 shows that an asymmetrical arrangement of the two photodetectors 7 relative to the optical axis 8 of the light source 6 is also possible. Consequently, the two photodetectors 7 each have a scattering angle θₛ⁽¹⁾ and/or θₛ⁽²⁾ relative to the optical axis 8.

The characteristic variable is thus a function of the two scattering angles θₛ⁽¹⁾ and θₛ⁽²⁾ as well as the refractive index m according to the following equation:

$$α ( {θ}_{S}^{( 1 )} , {θ}_{S}^{( 2 )} , m ) = \frac{Δ {t}_{00}}{Δ {t}_{11}} = \frac{\frac{d / 2}{v} [ cos ( \frac{{θ}_{S}^{( 1 )}}{2} ) + cos ( \frac{{θ}_{S}^{( 2 )}}{2} ) ]}{\frac{d / 2}{v} [ sin ( {θ}_{i , ( 1 )}^{p = 1} ( {θ}_{S}^{( 1 )} , m ) ) + sin ( {θ}_{i , ( 1 )}^{p = 1} ( {θ}_{S}^{2} , m ) ) ]} = \frac{cos ( \frac{{θ}_{S}^{( 1 )}}{2} ) + cos ( \frac{{θ}_{S}^{( 2 )}}{2} )}{sin ( {θ}_{i , ( 1 )}^{p = 1} ( {θ}_{S}^{( 1 )} , m ) ) + sin ( {θ}_{i , ( 1 )}^{p = 1} ( {θ}_{S}^{2} , m ) )} .$$

Corresponding relationships can also be formulated and calculated for the relationships of other time differences to one another as a function of the two scattering angles θₛ⁽¹⁾ and θₛ⁽²⁾ as well as the refractive index m, as already mentioned above such as, for example, Δt₀₁/Δt₀₀ or Δt₀₁/Δt₁₁.

1. A method for determining the size of a transparent particle, wherein the particle is illuminated with light from a light source, wherein a time-resolved intensity curve of light from the light source scattered on the particle is measured at a preselectable scattering angle θs using a radiation detector, wherein characteristic scattered light peaks are determined in the intensity curve, and wherein the size of the particle is determined on the basis of the time difference between two scattered light peaks, wherein either (i) a first and a second time-resolved intensity curve of light from the light source, scattered on the particle in the forward direction, is measured using two radiation detectors arranged on both sides of an optical axis of the light source, spaced a distance apart in the direction of the particle trajectory, or (ii) the particle is illuminated with two light sources spaced a distance apart from one another in the direction of the particle trajectory and arranged on both sides of an optical axis of the radiation detector, and the time-resolved intensity curve of light scattered in the forward direction, measured with the radiation detector, is broken down into a first intensity curve, caused by the first light source, and a second intensity curve, caused by the second light source; a transmission peak and a reflection peak are each determined from the first intensity curve and from the second intensity curve; a first time difference between two different transmission peaks and/or reflection peaks and a second time difference, which is different from the first time difference, between two different transmission peaks and/or reflection peaks, are determined; a characteristic variable α is determined from the ratio of the first time difference and the second time difference; and a size determination is performed only for the particles for which the characteristic variable α corresponds to a preselectable value.

2. The method according to claim 1, wherein either the two radiation detectors are arranged symmetrically on both sides of the optical axis of the light source and a first and a second time-resolved intensity curve of scattered light of the light source scattered on the particle in the forward direction is measured, or the two light sources are arranged symmetrically on both sides of an optical axis of the radiation detector, and the particle is illuminated by the two light sources arranged symmetrically and a distance apart in the direction of the particle trajectory.

3. The method according to claim 1, wherein the first time difference between the transmission peak of the first intensity curve and the transmission peak of the second intensity curve and the second time difference between the reflection peak of the first intensity curve and the reflection peak of the second intensity curve are determined.

4. The method according to claim 1, wherein the scattering angle θₛ or the scattering angle θₛ⁽¹⁾ and θₛ⁽²⁾ are predetermined, so that the characteristic variable α=Δt₀₀/Δt₁₁ is between 0.5 and 2.5.

5. The method according to claim 1, wherein one of several predetermined refractive indices m is assigned to the particle on the basis of the characteristic variable α.

6. The method according to claim 1, wherein a spatial intensity distribution of the light source along the optical axis is determined and is compared with an intensity distribution of the reflection peak and/or of the transmission peak over time.

7. The method according to claim 6, wherein a size determination is performed only for those particles for which the reflection peak and/or the transmission peak has an intensity distribution over time that correlates with the spatial intensity distribution of the light source.

8. The method according to claim 6, wherein the velocity v of the particle is determined from the width a of the intensity distribution of the reflection peak over time and/or from the width a of the transmission peak.

9. A device for determining the size of a particle using a light source having a radiation detector for light from the light source scattered by the particle and using an analysis unit that can be connected to the radiation detector for transmission of data, wherein two radiation detectors are arranged in the forward direction on both sides of an optical axis of the light source spaced a distance apart in the direction of the particle trajectory or two light sources are arranged in the forward direction on both sides of an optical axis of the radiation detector spaced a distance apart in the direction of the particle trajectory, wherein the light source or the light sources are situated on a first side of a measurement volume and the radiation detector or the radiation detectors are situated on opposite sides of the measurement volume.

10. The device according to claim 9, wherein the two radiation detectors are either arranged symmetrically on both sides of an optical axis of the light source at a scattering angle θs which is the same by amount in the forward direction or at a distance apart from one another in the direction of the particle trajectory, or the two light sources are arranged symmetrically on both sides of an optical axis of the radiation detector at a scattering angle θs which is the same by amount in the forward direction with a distance between them in the direction of the particle trajectory.

11. The device according to claim 9, wherein the light source emits light that is not coherent.

12. The device according to claim 11, wherein the light source has an LED.

13. The device according to claim 9, wherein the light source creates a light curtain.

14. The method according to claim 4, wherein the scattering angle θₛ or the scattering angle θₛ⁽¹⁾ and θₛ⁽²⁾ are predetermined, so that the characteristic variable α=Δt₀₀/Δt₁₁ is approximately 1.5
